(19) United States
(12) Patent Application Publication
(10) Pub. No.: US 2007/0088495 A1
(43) Pub. Date: Apr. 19, 2007

(54) System and method for identifying information for a fixed location

(76) Inventor: Wael M. Ibrahim, Cypress, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/252,948

(22) Filed: Oct. 18, 2005

(51) Int. Cl. G01C 21/00

(52) U.S. Cl. 701/206; 340/991; 340/539.13

(57) ABSTRACT

Method for identifying information for a fixed location. An initial signal is wirelessly transmitted from a mobile unit locally to a receiver at the fixed location. The receiver receives the initial signal and automatically wirelessly transmits a return signal locally to the mobile unit indicating the information for the fixed location. The return signal is received by the mobile unit and processed to extract the identifying information.

### BACKGROUND OF THE INVENTION

The invention relates generally to the field of wireless communication.

In traveling, delivery, or other activities requiring transportation, it may be useful to determine an address or other information for a fixed location, such as a residential or commercial building. However, such addresses or information may be difficult to obtain when in a mobile environment.

For example, a vehicle operator may wish to locate a particular address for delivering a package. If the vehicle operator has access to a location determining system such as a global positioning system (GPS), he or she may be able to map this location onto a database of known addresses, and use this database to determine a particular address.

However, this approach has several limitations. It may be difficult to obtain GPS coordinates that are sufficiently precise to differentiate between adjacent fixed locations. Additionally, the database may be unavailable to the vehicle operator, or it may be difficult to review, for example, when driving. Also, the database may not be current enough to determine the current address.

An alternative approach employs a map or a mapping program. However, this approach also suffers from difficulty to review when driving and from the possibility that the map in use has not been updated.

Still another approach is using a mobile phone or other device linked to a cellular network. However, this approach may be unreliable in certain instances due to signal loss. Also, while it may be possible, for example, to use a mobile phone to call a person in the building to confirm an address, this approach is intrusive, and it will be unsuccessful if the occupant is unavailable.

Address markings (such as signs) on buildings fail to address these concerns, because the markings are often difficult to view or may not be present at all. Further, a vehicle operator may not be able to view a marking to confirm or reject a particular building until moving the vehicle to the particular building and/or exiting the vehicle to approach the marking, which is inefficient.

It may also be desirable to receive other information related to a fixed location, such as status information, utility usage, etc., without needing to manually investigate each separate location. In still other instances, it may be desirable to transmit a message efficiently, such as an emergency or consumer-related message, on a local scale to one or more fixed locations.

### SUMMARY OF THE INVENTION

Embodiments of the present invention provide, among other things, a method of identifying information for a fixed location. An initial signal is wirelessly transmitted from a mobile unit locally to a receiver at the fixed location. The initial signal is received by the receiver, and a return signal is automatically wirelessly transmitted locally to the mobile unit indicating the information for the fixed location. The return signal is received by the mobile unit, and is processed to extract the identifying information.

In an alternative method of identifying information for a fixed location, a periodic or continuous signal is wirelessly transmitted within a local area that uniquely represents the information by a unit at the fixed location. The transmitted signal is received by a mobile unit entering the local area, and mobile unit processes the received signal to extract the identifying information.

Additional embodiments of the present invention provide a system for identifying information for a fixed location. The system comprises a base unit in which is stored the information for the fixed location. The base unit includes an antenna and a transmitter for wirelessly transmitting a signal indicating the information for the fixed location within a local area. The system also comprises a mobile unit including an antenna and a receiver for receiving the wirelessly transmitted signal when the mobile unit is within the local area. The mobile unit further includes a processor for processing the received signal and extracting the identifying information.

A system for transmitting a consumer or alert message to a fixed location according to alternative embodiments of the present invention comprises a mobile unit in which is stored the consumer or alert message, the mobile unit including an antenna and a transmitter for wirelessly transmitting a signal indicating the consumer or alert message within a local area of the fixed location. The system further includes a base unit having an antenna and a receiver for receiving the wirelessly transmitted signal when the mobile unit is within the local area. The base unit further comprises a processor for processing the received signal and extracting the consumer or alert message.

### BRIEF DESCRIPTION OF THE DRAWINGS

FIG. 1 illustrates a system for obtaining information for a fixed location, according to a preferred embodiment of the present invention;

FIG. 2 is a schematic diagram of a base unit used at a fixed location;

FIG. 3 is a schematic diagram of a mobile unit incorporated into an automobile;

FIG. 4 is a flow diagram illustrating steps in a preferred operation of a base unit;

FIG. 5 is a flow diagram illustrating steps in a preferred operation of a mobile unit;

FIG. 6 shows an exemplary mobile unit display;

FIG. 7 illustrates a system for obtaining information for a fixed location according to another embodiment of the present invention;

FIG. 8 is a flow diagram illustrating steps in an alternative operation of a base unit;

FIG. 9 is a flow diagram illustrating steps in an alternative operation of a mobile unit; and

FIG. 10 illustrates a system for obtaining information for a fixed location, according to another embodiment of the present invention including a remote unit.

### DETAILED DESCRIPTION

Preferred embodiments of the present invention provide various systems, apparatus, and methods by which information, such as address or other information, for a fixed location, such as a residential or commercial building, can be determined. Preferred embodiments of the present invention allow drivers or pedestrians, for example, to locate a correct street address number. Often, the street address is difficult to find; for example, numbers may be obstructed or insufficiently lighted, etc. A preferred method, apparatus or system may complement or replace current auto navigation software.

Generally, wireless communication is provided between a base unit at a fixed location and a mobile unit of a moving vehicle or a pedestrian. Exemplary methods according to the present invention can be classified generally depending on whether communication between the base unit and the mobile unit is primarily two-way or one-way, and if one-way, whether the communication initiates from the base unit or the mobile unit.

In an exemplary embodiment using two-way communication, a method of identifying an address or other information for a fixed location includes wirelessly transmitting an initial signal from a mobile unit to a base unit at a fixed location. The base unit, in response to the initial signal, automatically wirelessly transmits a return signal uniquely indicating an address or other information for the fixed location. The mobile unit receives the return signal and processes the return signal to identify the address or other information. In two-way communication, the base unit may act as a transponder.

In two-way embodiments, the initial signal may be a query (interrogation) submitted to the base unit, and the base unit may be configured to respond to the query by sending a return signal. An initial signal may additionally or alternatively include information that the owner of the vehicle desires to transmit to the base unit. For example, such information may include consumer information, alerts, etc.

The return signal, for example, may include a code representing an address or other information, and processing of the return signal may include, for example, decoding the return signal. Such decoding may include decrypting the transmitted signal, comparing the signal to a database and/or lookup table, or other decoding methods. The processing may also include, for example, filtering the information transmitted by the return signal according to desired criteria. The return signal may include an RF or other wireless signal, for example. Fixed locations, for example, may include a residential or commercial building, or they may include a stand-alone fixed location such as a base, an antenna tower, etc. for transmitting return signals.

In an alternative method for identifying an address or other information for a fixed location using one-way communication, the base unit periodically or continuously wirelessly transmits a signal uniquely representing the address or other information within a particular area. For example, the area may be a broadcast or a narrow cast zone. In one-way communication, the base unit may act as a beacon.

A mobile unit within the area receives the transmitted signal and processes the received signal to identify the address or other information. For example, the transmitted signal may be decoded similarly to two-way embodiments. The processing, for example, may include decoding the received signal, and also may include filtering information according to desired criteria.

The base unit, for example, may include a device integrated with a personal computer at a home, a stand-alone device that attaches to a building (either inside or outside) or is placed outside of the building, or a device integrated with another type of transmitting device (such as a cell phone (mobile phone) or similar device). Examples of the base unit include a transceiver that may be connected to a residential or commercial building, an apparatus integrated with a computer or other electronic device, or a remote unit, where a central device acts as a receiver for a number of base units and transmits a plurality of signals for receipt by the mobile unit.

Examples of the mobile unit include devices integrated into electronics for a vehicle or personal electronics. Other examples include a cell phone (mobile phone), a personal digital assistant (PDA) or other portable communication device, or a laptop computer. The mobile unit allows a driver or pedestrian to communicate with the base unit.

Additionally or alternatively to a base unit at the fixed location wirelessly transmitting the signal, it is further contemplated that the signal may be sent to a remote unit, such as a repeater, relay, or other centralized unit, and the remote unit may itself transmit the signal in particular embodiments, along with signals from other base units to provide a plurality of signals. This plurality of signals may be aggregated and/or divided as necessary or as desired. In this way, the area for transmitting signals may be made wider than the area permitted by a single base unit for a particular fixed location.

In preferred embodiments, one or more remote units may transmit the plurality of signals, which may be processed to determine a plurality of addresses or other information regarding the fixed locations in its vicinity. However, it is preferred that the emitted signals have a local origin; that is, the signals from the base unit, mobile unit, and/or remote unit preferably are not cellular signals, connected to a wide-area network, but are intended to be transmitted and received within a localized area or area network. Most preferably, in embodiments of the present invention, communication is either directly between the base unit and the mobile unit, or it is relayed only via the locally disposed remote unit.

Preferred examples of wireless communication include Bluetooth, IEEE 802.1X, radio frequency (RF) communication, etc. It is contemplated that any suitable wireless communication that allows transmitting of a sufficient signal from the base unit to the mobile unit and in some embodiments, vice versa, to permit transmission of an address or other information as desired will be suitable as a type of wireless communication.

Address information, for example, may include a street address for a building. Other information may be transmitted by the base unit, and may include, for example, ownership or occupant information for the building, status information, a transmitted message (such as, but not limited to, a consumer message), etc. Information received by the mobile unit may also be stored, displayed, or otherwise made available to an operator.

By transmitting the address or other information from the base unit to the mobile unit, a user, such as an operator of a moving vehicle, can determine if a particular fixed location is a correct destination, for example. If the transmitted signal represents information other than an address, such as an advertisement, the operator of the moving vehicle can use this information to determine if he or she wants to stop at the fixed location.

In this way, it is contemplated that address information and/or other information may be transmitted (directly or only via one or more locally disposed remote units) between a fixed location and a moving vehicle or pedestrian in an area of the fixed location efficiently and effectively, without resorting to global positioning satellite (GPS), cellular networks, or other large-scale methods of address identification.

In alternative embodiments, a signal may be sent from the mobile unit to the base unit or the remote unit including information other than that for interrogation. For example, the mobile unit may transmit alert information or consumer information wirelessly to the base unit or mobile unit, and such information, for example, may be stored and/or displayed. Such transmission may be one-way (from the mobile unit only) or two-way (in combination with a return signal from the base unit).

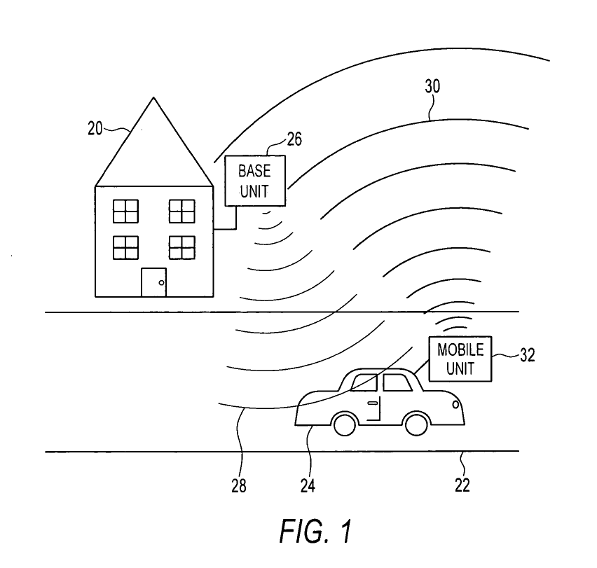

Referring now to the drawings, FIG. 1 shows a fixed location 20 embodied in a residential building positioned along a street 22. A motor vehicle 24 passes by the fixed location 20 and enters an area near the fixed location. A base unit 26 of the fixed location 20 is configured to transmit a wireless signal 28 indicating, for example, an address of the fixed location in response to an initial signal 30 sent from a mobile unit 32 of the moving vehicle 24. The area near the fixed location 20 within which the mobile unit 32 (in the exemplary embodiment, via the moving vehicle 24) passes should be sufficiently proximate to the fixed location to receive the wireless signal 28 and to transmit the initial signal 30 for receipt by the base unit 26. It is contemplated that the broadcast area be relatively short range broadcast, for example, enough to be received by traffic on a street adjacent to the fixed location (vehicle and/or pedestrian traffic), but preferably not so wide an area to interfere with similar broadcasts generated by other, nearby fixed locations.

The base unit 26, for example, may be implemented as a stand-alone device located outside the fixed location 20, sufficiently close to the street 22 for successful wireless transmission. The base unit 26 in an exemplary embodiment may be a small device located within range of traffic (vehicle and/or pedestrian traffic). For example, the base unit 26 may be located at the top or the side of a fixed location 20, in front of the fixed location, away from the fixed location (for example, next to a mailbox), and/or may be located near the street 22, for example, on or in a post near the street. Such exemplary locations are not intended to limit the invention to a particular location of the base unit 26 relative to the fixed location 20.

Alternatively, the base unit 26 may be implemented within the fixed location 20, for example, as a modular attachment to a home computer, such as a personal computer with or coupled to an RF antenna that allows transmitting the signal 28 to the mobile unit 32. The antenna, for example, may be disposed inside or outside of the fixed location 20. In yet another alternative embodiment, the base unit 26 may be integrated into the personal computer, or into another electronic device such as a mobile phone, wireless router or repeater, or any suitable device configured to perform one or more methods according to the present invention.

In this way, by the term “base unit” it is to be understood that it is not required for the base unit 26 to be at a particular location in or on the fixed location 20. It is only necessary for the base unit 26 to be able to transmit the wireless signal 28 within a particular area for receipt by the mobile unit 32 when it enters an area near the fixed location 20.

The mobile unit 32 transmits the initial signal 30 to the base unit 26 and receives the return signal 28 from the base unit. Preferably, the return signal 28 uniquely identifies the address of the fixed location 20 or includes other information relating to the fixed location. The mobile unit 32 may be implemented by, for example, a computer integrated with electronics of the moving vehicle 24, a handheld device such as a personal digital assistant (PDA), a mobile phone, a laptop computer, or other device. Alternatively, the mobile unit 32 may be a stand-alone unit configured to transmit the initial signal 30 and receive and process the return signal 28. For example, the mobile unit 32 may be a stand-alone device transported within the motor vehicle 24, or by a pedestrian (such as, but not limited to, a mail carrier or delivery carrier) that walks by the fixed location 20.

As shown in FIG. 1, the base unit 26 and the mobile unit 32 are in sufficient proximity to one another so that both the initial signal 30 transmitted from the mobile unit to the base unit and the return signal 28 transmitted from the base unit to the mobile unit may be received by their respective receivers. Thus, the mobile unit 32 is permitted to query the base unit directly for an address or other information, for example, and the base unit is able to transmit the request information directly to the mobile unit, without requiring large-scale communication systems or methods, such as GPS or a cellular network, for example.

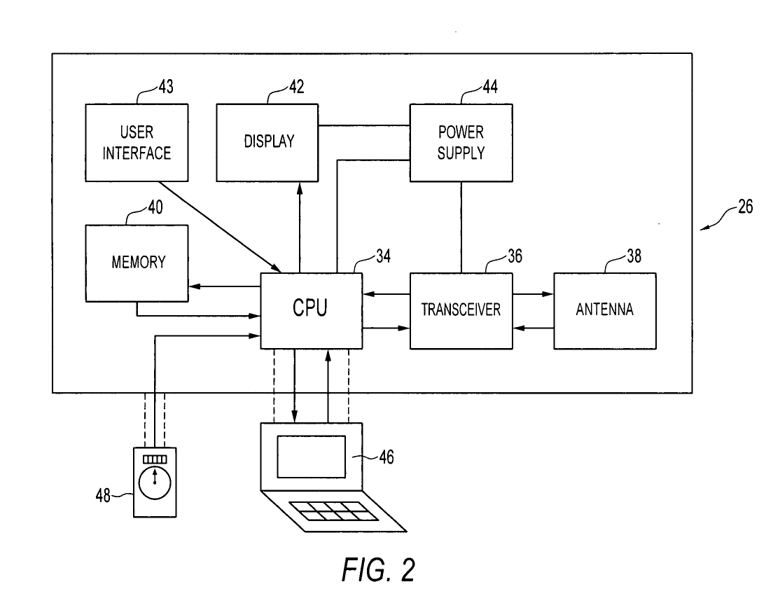

FIG. 2 shows an exemplary base unit 26, which may be configured to act as a transponder. The base unit 26 in the exemplary embodiment shown includes a processor, such as a central processing unit (CPU) 34 with suitable processing ability and integrated or connected memory (for example random access memory (RAM)) for performing one or more methods disclosed herein. The CPU 34 is configured as necessary to perform particular methods as described herein.

The CPU 34 receives signals from and sends signals to a transceiver 36, which itself is coupled to an antenna 38. Suitable interfaces between the CPU 34 and the transceiver 36 will be appreciated by those of ordinary skill in the art. Alternatively, a separate receiver and transmitter may be used in place of the transceiver 36. The transceiver 36 and the antenna 38 operate to receive the initial signal 30, which is sent to the CPU 34 for processing. Particular methods will be apparent to those of ordinary skill in the art. To transmit the return signal 28, including address or other information, the CPU 34 sends an appropriate signal to the transceiver 36, which in turn uses the antenna 30 for wirelessly transmitting the information.

Memory 40 (for example, nonvolatile memory) may be coupled to the CPU 34 for nonvolatile storage of information relating to operation of one or more methods disclosed herein. For example, the memory 34 may be used to store a record of queries sent via one or more initial signals 30 from one or more mobile units 32. Alternatively or additionally, the memory 40 may be used to store specific messages from the mobile unit 32 such as advertisements, alerts, etc. It is contemplated that messages may be stored within the CPU 34, for example, as firmware.

In some preferred embodiments, a display 42 controlled by the CPU (via a suitable interface) permits visualization of particular information sent via the initial signal 30. For example, the display 42 may present alert information sent from the mobile unit 32 or may be used as identification for the mobile unit that is sending out the initial signal 30. However, the display 42 may be omitted in other embodiments. A user interface 43 preferably is provided for receiving user input. For example, a keypad, touch screen, connection to outside input device, etc., may be provided. However, it is alternatively contemplated that the base unit 26 may operate automatically, without user input. A suitable power supply 44 supplies power to the display 42, CPU 34, transceiver 36, etc. In a low-power operation, the initial signal 30 from the mobile unit 32 may also be used to provide power for operation of the base unit 26. In this case, appropriate induction, rectifying, etc. components may be incorporated into the base unit 26.

It is contemplated that the base unit 26 may be coupled to an outside device such as a personal computer 46 for exchange of information. For example, it is contemplated that information messages for transmission, criteria for processing the initial signal 30, etc. may be supplied to the base unit 26 at least partially via the PC 46, or that information that is received by the base unit may be transmitted or stored via the PC. Alternatively, the base unit 26 may be integrated with such an outside device. For example, the CPU 34, transceiver 36, antenna 38, memory 40, display 42, and power supply 44 may be integrated into the personal computer 46 (for example, components of the personal computer may perform respective functions of the base unit 26 components), so that it is configured to perform one or more methods according to the present invention. It is contemplated that one or more particular components of the base unit 26 may be incorporated in different electronic devices, and further that the configuration shown in FIG. 2 is not intended to be the only configuration for the base unit.

In particular embodiments, the base unit 26 may be coupled to one or more meters 48 via appropriate interfaces for receiving signals relating to status information for the fixed location 20. For example, signals for electricity, water, or gas usage, etc., may be transmitted to the CPU 34 for displaying on the display 42, storing in the memory 40, and/or for transmitting to the mobile unit 32 as fixed location information. In an exemplary embodiment, a meter reader may drive by the fixed location 30 with the mobile unit 32 and send out the initial signal 30 including a query for reading a water meter. The CPU 34 receives a signal from the meter 48 (or may query the meter and receive a reply signal), and information may be transmitted via the transceiver 36 and the antenna 38 for receipt by the mobile unit 32.

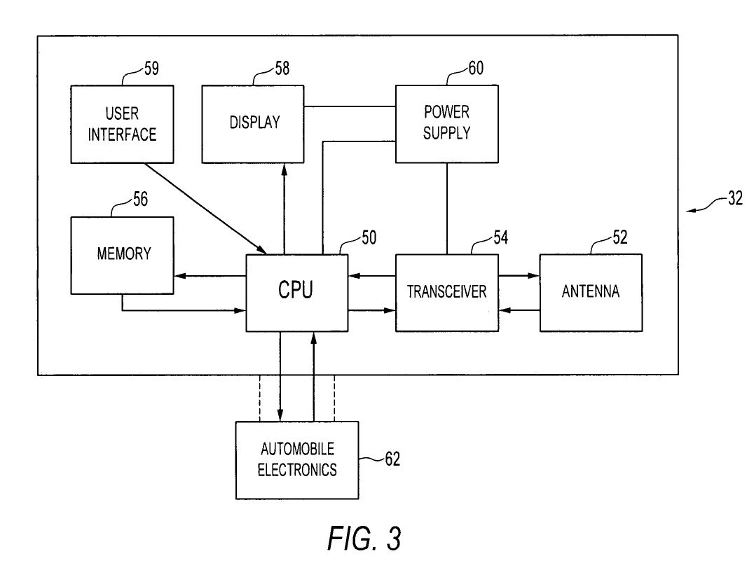

FIG. 3 shows an exemplary configuration for the mobile unit 32. A processor such as a CPU 50 with suitable processing and memory (for example, RAM) is included in the mobile unit 32. An antenna 52 and the transceiver 54 (or separate transmitter and receiver) coupled to the CPU 50 via a suitable interface allow transmission of the initial signal 30 and receiving and processing of received return signals 28. For example, the antenna 52 and the transceiver 54 may transmit the initial signal 30, such as a query, to the base unit 26, and the CPU may receive and process the return signal 28, indicating address information for the fixed location 20.

Preferably, the mobile unit 32 further includes nonvolatile memory 56 for storing information provided by processing the received return signals 28 and/or other information. For example, a series of addresses received or a series of meter readings may be stored within the nonvolatile memory 56. In an alternative embodiment, if the mobile unit 32 is used to transmit consumer or alert information, the memory 56 may be used to store this information before processing by the CPU 50 and transmitting by the transceiver 54 and the antenna 52. In an alternative embodiment, the mobile unit 32 may be configured to forward received signals or processed information to an outside device. In such a case, the nonvolatile memory 56 may be omitted if desired.

The mobile unit 32 preferably further includes a display 58 (with appropriate interface) for providing visual indication of information received by the mobile unit 32, with or without further processing. A user interface 59 also may be provided for receiving user input. For example, a touch screen, keypad, or interface with outside devices (for example, inputs within the vehicle 24) may be provided. However, it is also contemplated that the mobile unit 32 may operate automatically, without user input. A suitable power supply 60 provides power for the display 58, the CPU 50, and/or the transceiver 54.

It is contemplated that the mobile unit 32 may be fully or partially integrated into one or more different devices, which may be personal devices or part of the vehicle 24. For example, the mobile unit 32 shown in FIG. 3 may be coupled to automobile electronics 62 via a suitable interface for sending and receiving signals. In an exemplary method, the mobile unit 32 may send signals relating to address information to the automobile electronics 62 for displaying, for example, on a dashboard. In another example, it is contemplated that the automobile electronics 62 may include mapping or other information that may be combined with the information provided from the received return signal 28 so that this combined information may be made available to a user.

As another example of integration, it is contemplated that the mobile unit 32, including the CPU 50, transceiver 54 (such as an RF transceiver), nonvolatile memory 56, antenna 52, display 58, power supply 60, etc., may be fully or partially incorporated into any of an automobile computer, personal digital assistant (PDA), mobile phone (such as a cell phone) and/or a laptop or other personal computer.

It is alternatively contemplated that the mobile unit 32 may be a stand-alone device. The antenna 52 may be separate, but coupled to the remainder of the mobile unit 32. For example, the antenna 52 may be placed outside the vehicle 24 and wired to the mobile unit.

The type of transmission from the transceiver 36, 54 and antenna 38, 52 from either the base unit 26 or the mobile unit 32 according to embodiments of the present invention is contemplated to be any suitable wireless transmission sufficient to transmit and receive appropriate signals within a local area that are capable of being received and processed by the respective CPUs 34, 50. In a preferred embodiment, Bluetooth (for example, class 1) may be used as a wireless transmission method for transmitting the initial signal 30 and/or the return signal 28. Alternatively, IEEE 802.1X or other RF signals may be used.

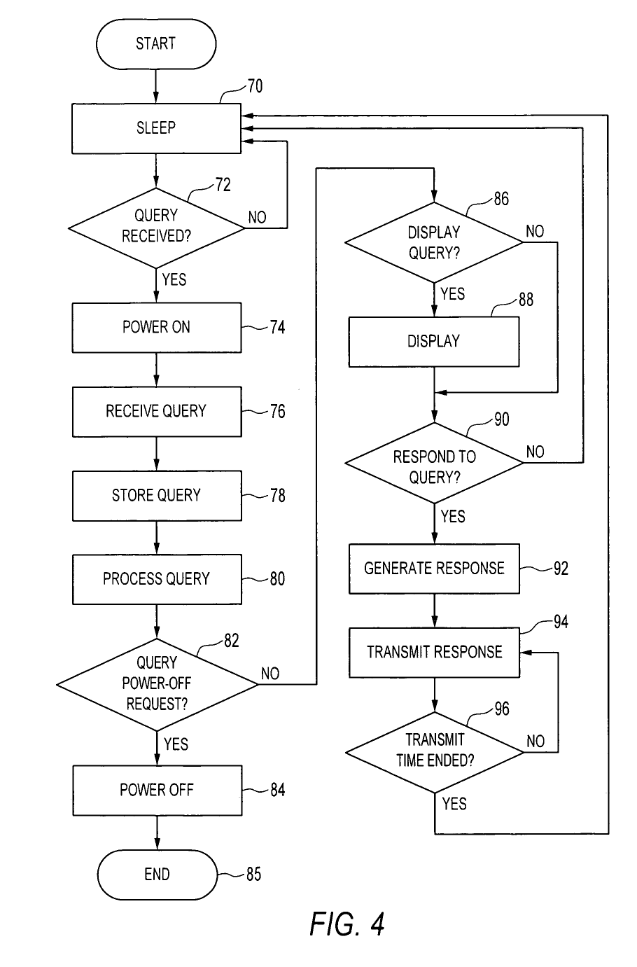

FIG. 4 shows an exemplary process for operation of the base unit 26 according to embodiments of the present invention. The base unit 26, for example, may initially be in a sleep mode (step 70) and periodically check (step 72) for an interrupt such as the initial signal 30. The initial signal 30, as stated above, may be a query (interrogation) signal from the mobile unit 32. It is contemplated that the initial signal 30 may include an interrupt and a query signal. If no query is received, the base unit 26 continues in sleep mode (step 70). When a query is received, the base unit 26 powers on (step 74) and receives the initial signal 30 (query) (step 76). The received query preferably is stored (step 78), for example, within RAM of the CPU 34 and/or the nonvolatile memory 40, and the query is processed (step 80) to determine information, for example pertaining to the type of query, the subject of the query, and/or any information about the sender of the query.

If the query is a power off request (step 82) the base unit 26 then powers off (step 84) and the process ends (step 85). If the query is not a power off request, the base unit 26 preferably determines (step 88) based on the processing step (step 80) whether or not the subject matter or other information related to the query is to be displayed, or if a response is to be generated. If the information is to be displayed, such information is displayed (step 88), for example, on the display 42. If alternatively, the base unit 26 is configured not to display certain information (for example, if the sender of the information is on a list of unauthorized senders or particular information, such as consumer information, is desired not to be displayed), the information is not displayed.

The base unit 26 then determines (step 90) based on the processing step (step 80) whether or not to respond to the query. If, for example, the query can be responded to and if response is appropriate, a response is generated (step 92) and transmitted (step 94) via the transceiver 36 and the antenna 38 within the local broadcast or narrowcast area, for example, as shown in FIG. 1. The message generated in step 92, for example, may be a standard or default message programmed into the base unit 26 (such as a message transmitting an address), a more customized message, such as a message selected from a list of programmed standard responses (for example, “I am not home”) and/or customized responses selectively programmed by a user. If, on the other hand, upon determining (step 90) that a response is not to be generated (for example if the mobile unit 32 is unauthorized, the initial signal 30 is not to be responded to, or the owner of the fixed location 20 simply desires not to be disturbed) then no response is generated. The base unit 26 then may re-enter sleep mode (step 70). Alternatively, it is contemplated that the base unit 26 may be configured to transmit the return signal 28 in all cases in response to the initial signal 30. In such embodiments, the determination step 90 may not be necessary.

The return signal 28 may be transmitted (step 94), for example, continuously over a predetermined period of time, or repeated a predetermined number at times at particular intervals. Such intervals may be, for example, may be within fractions of a second or on the order of seconds, and the length of time for such continuous or repeated transmissions may vary from on the order of seconds to a minute, for example. The particular transmission intervals and/or the transmission times disclosed herein are not intended to limit the scope of the present invention. When the transmit time has ended (step 96), the process ends, and the base unit 26 may return to sleep mode (step 70). It will be understood that the order of the steps shown in FIG. 4 may be varied as needed or desired.

Thus, if the operator of the base unit 26 refuses to give responses to certain devices or queries, then the base unit preferably does not provide such a response. On the other hand, if the base unit 26 is able to and the operator is willing to provide information, a response (the return signal 28) is transmitted locally within the broadcast or narrowcast area. Further, in a preferred embodiment, the base unit 26 may be normally off or in sleep mode for power-saving purposes, for example, and configured only to awaken to send responses to queries from the mobile unit 32.

The base unit 26 may be programmed to have different responses to particular users, or to particular queries, to implement customizable policies as determined by an operator. For example, depending on identification provided by the processing step (step 80), the base unit 26 may generate a response (the return signal 28) (step 92) by associating the identification of the mobile unit 32 with a particular predetermined response. As another example, a particular query may be sent from the mobile unit 32 requesting information determined by searching data available to the base unit 26. The base unit 26 may respond after processing the query by retrieving the requested information and delivering it to the mobile unit 32 via the return signal 28. Response policies may be customized depending on various parameters.

As a more specific, nonlimiting example, a delivery truck may wish to deliver a package requiring a signature. When the initial signal 30 is sent from the mobile unit 32 of the delivery truck querying the fixed location 20 for an address, the return signal 30 may be sent from the base unit 26 with a message indicating that the occupant of the fixed location is not present, and thus will not be available to sign for a package. However, the owner of the fixed location 20 may not wish to broadcast this information to other passers-by. Thus, depending on the result of the processing step (step 80), an appropriate message may be sent to intended recipients only.

Because, preferably, the queries received are processed (step 80) and stored (step 78) and/or displayed (step 86) by the base unit 26, it is contemplated that an operator of the base unit may be able to inquire as to who was requesting his or her address or other information. By referring to the display 42 and/or querying the memory 40 of the base unit 26, such information can be determined. It is also contemplated that a record of the outgoing return signals 26 may be stored by the base unit 26 for record keeping or later referral. In alternative embodiments, it is contemplated that identification information from the mobile unit 30 in certain instances may be kept private.

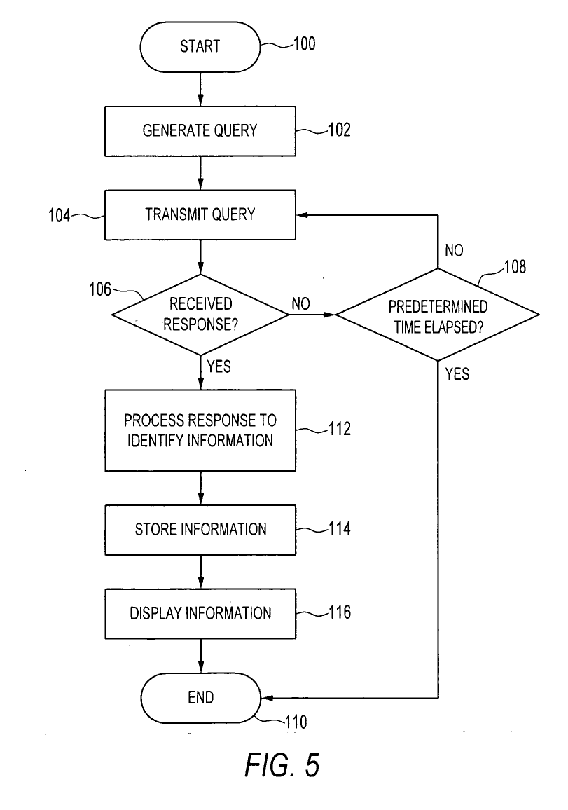

FIG. 5 illustrates a method for operation of the mobile unit 32 in an exemplary embodiment. The mobile unit 32 in this exemplary embodiment is configured to transmit the initial signal 30, such as a query (interrogation), to the base unit 26 and to receive and process a response based on the transmitted return signal 28 from the base unit. For example, upon startup (step 100) or upon specific activation by an operator, the mobile unit 32 generates a query (step 102) using the CPU 50 in combination with any necessary information stored within the nonvolatile memory 56. This query is transmitted (step 104) as the initial signal 30 from the antenna 52 within the broadcast or narrowcast area (see FIG. 1) of the mobile unit 32.

In a preferred embodiment, the mobile unit 32 may be controlled via customized policies for query generation (step 102). For example, the mobile unit 32 may be configured to generate a query obeying particular criteria as set by the operator. If, for example, an operator wishes to find a particular food item at a restaurant, the query generation step (step 102) may include querying for the item or generally for available specials. The query may be further customized, such as by querying for the item at or less than a particular price.

The transmission (step 104) preferably lasts for a predetermined period of time. For example, the initial signal 30 may be transmitted (step 104) by the mobile unit 26, and then the mobile unit may check (step 106) to see if a response is received. If a response is not received, then the CPU 50 may determine (step 108) whether a certain amount of time has elapsed. In this way, if a predetermined time has elapsed, it may be concluded that no return signal is forthcoming, and thus the mobile unit 32 should cease generating the query. If so, the process ends (step 110). If a predetermined time has not elapsed, then the query is retransmitted (step 104). The length of predetermined time for querying the base unit 26, the intervals between initial signal transmissions (or if the transmission is continuous), and/or the length of time of a particular transmission can vary as needed or desired, and it is contemplated that the invention should not be limited to particular transmission intervals or times.

If a response is received (step 106) via the antenna 52, the response is processed (step 112) to identify the information transmitted from the base unit 26. For example, the information processed may relate to the address of the fixed location 20. Alternatively, the response may be processed to determine other information sent from the base unit 26, such as a meter reading, a selected message, etc.

The following illustrates exemplary methods for processing (step 112) to identify the information stored within the return signal 28. If the return signal 28 from the base unit 26 is encoded, the information may be decoded. For example, such decoding may include decrypting the transmitted signal, comparing the signal to a database and/or lookup table, or other decoding methods. Alternatively, received information may be compared to a table, such as a relational database table or a lookup table, to determine, for example, the address for the fixed location 20. Such a relational database or lookup table may or may not be integrated into the mobile unit 32.

For example, it is contemplated that a table storing codes for addresses may be stored at a site remote from the mobile unit 32 and accessed by the mobile unit, for example, via wireless mobile communication, wireless internet, satellite, etc. However, as opposed to relying solely on GPS or other large-scale processes, the information provided by exemplary embodiments of the present invention is at least partially provided via communication directly from a device (i.e., the base unit 26) at the fixed location 20 itself. In this way, the information is less likely to be obsolete than, for example, mapping information typically integrated with conventional GPS systems.

The processing step (step 112) preferably can be customized by an operator to filter responses according to policies. For example, a query for food items from a restaurant may provide a response that is filtered to only retain those items at or below a given price. As another example, a query for an address may have a response that is filtered to only show a specific address.

The information determined by processing the response (step 112) may be stored (step 114), for example, in the memory 40 of the mobile unit 30 or other location (internal or external) for record-keeping, for later reference, etc. Further, the information may be displayed (step 116) on the display 58 of the mobile unit 32 or other display for visual identification by an owner.

In alternative embodiments, the initial signal 30 transmitted from the mobile unit 32 may include information additional or alternative to address query information. For example, the initial signal 30 transmitted in step 104 may not be a true query, but instead may include consumer information and/or alert information. In these cases, the amount of predetermined time during which the initial signal transmission takes place may not be as long as for a query, because the mobile unit 32 may not wait for a return signal and/or retransmit the initial signal. Such a case may include, for example, a one-way communication originating from the mobile unit 32. However, it is alternatively contemplated that the mobile unit 32 may receive a return signal from the base unit 26 indicating that the consumer or alert information was received, so that a suitable record may be stored, for example, within the memory 56 of the mobile unit.

For a one-way communication originating from the mobile unit 32 to transmit a consumer or alert message to the fixed location 20, the operations and/or components of the mobile unit and/or base unit 26 may be simplified. For example, the mobile unit may be configured to generate a message (step 102) to transmit via the initial signal 30, using one or more of the methods as described herein, and then transmit the message (step 104) to the fixed locations 20 as the mobile unit is transported within the fixed locations' local area. The steps relating to processing a response, and related components, may be omitted if desired. Similarly, the base unit 26 may be configured to receive (step 76) and process (step 80) the initial signal 30, and then store and/or display the message according to the configuration using one or more of the methods described herein. The steps relating to generating and transmitting a response, and related components, may be omitted if desired.

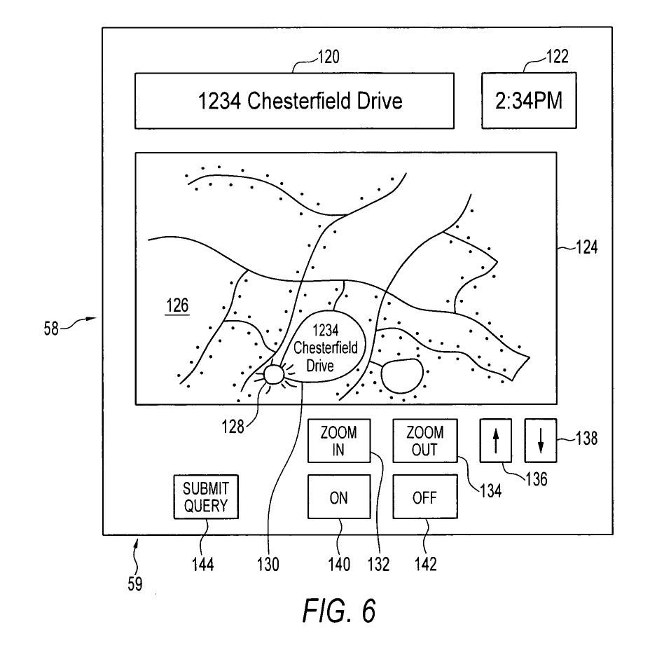

FIG. 6 shows an exemplary display 58 for the mobile unit 32. The display 58 includes a text display 120 which provides a visual indication of the street address of the fixed location 20 or other text identification. As shown in FIG. 6, the address transmitted by the fixed location 20 and presented via the text display 120 is “1234 Chesterfield Drive”. A time display 122 may also be provided.

Further, a graphical display 124 may be provided, which graphically indicates a relative location of the fixed location 20 or provides other graphical information (photo of occupant, etc.). For example, a suitable mapping program may be integrated with the mobile unit 32 to provide display information, and the address may be separately provided on the display 124 for indicating the particular whereabouts of the fixed location 20 within a larger area, such as a city block or neighborhood. As shown, the fixed location located at 1234 Chesterfield Drive is indicated on a street map 128. A balloon 130 window, tool tip, or other indicator may be also provided to visually link the determined address with the rest of the graphical display 124. Additionally, or alternatively, the graphical display 124 may display an arrow pointing at the direction between the driver, for example, and the house or a driving direction along the map. The display 58 may be incorporated with the user interface 59.

The mobile unit may include one or more additional controls for operation via the user interface 59. For example, “zoom in” and “zoom out” buttons 132, 134 or “up” or “down” arrows 136, 138 may be used to navigate the graphical display 124 to better view particular information provided by the graphical display, or to navigate different messages on the textural display 120. On and off power buttons 140, 142 may be supplied. Additionally, a “submit query” button 144 or similar control may be used to initiate transmitting the initial signal 30 from the mobile unit 32 to the base unit 26.

In a second principal type of embodiment and method of the present invention, instead of the base unit 26 sending a signal in response to the initial signal 30 from the mobile unit 32, the base unit may be configured to continuously or periodically transmit information relating to the fixed location 20, such as address or status information, without waiting for an initial signal. In this preferably simpler mode of operation based on one-way communication from the base unit 26, the base unit does not respond to queries, but instead it merely transmits information. The base unit 26, according to this alternative embodiment, may have a simpler configuration, though this is not required.

In an exemplary embodiment, referring again to FIG. 2, the base unit 26 may include a transmitter instead of the transceiver 36 or transmitter and receiver combination, the display 42 may be omitted, the memory 40 may be reduced or eliminated (for example, replaced with a message stored within firmware or hard-coded), the CPU 34 may be significantly simplified or replaced with, for example, a simple chip, and/or other modifications may be made. For example, the user interface 43 may be simplified so that the owner may only be able to turn the base unit 26 on or off and/or select a message for continuous or periodic transmission. It is contemplated that such a base unit 26 may be provided, for example, at a lower cost than a base unit configured to perform one or more of the more complex methods described above.

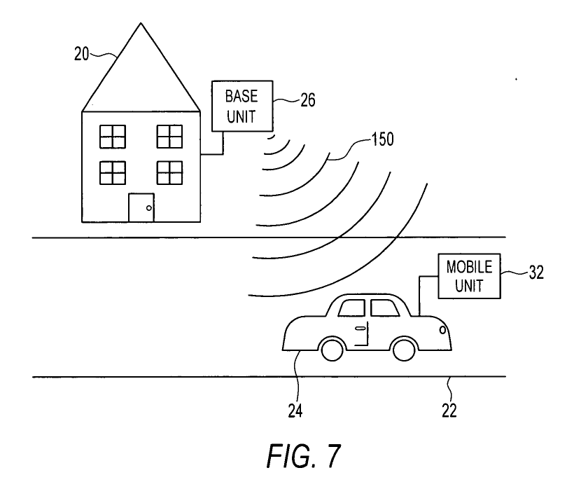

FIG. 7 illustrates an exemplary method of operation for the base unit 26 according to embodiments of the present invention incorporating one-way transmission from the base unit. As shown in FIG. 7, the base unit 26 transmits a continuous or periodic signal 150 within a broadcast or narrowcast area, acting generally as a beacon. In this way, as opposed to being configured as a passive device, as in embodiments using two-way communication, the base unit 26 is configured to operate as an active device in the sense that it initiates the process for the mobile unit 32 determining an address or other information for the fixed location 20. In the case of identifying information for a fixed location, for example, the signal 150 uniquely represents the identifying information.

As also shown in FIG. 7, the mobile unit 32 in this exemplary type of embodiment does not generate an initial signal, but instead it merely receives the transmitted signal 150 from the base unit 32 and processes the signal to determine address or other information. In this way, the mobile unit 32 can also be made simpler in exemplary embodiments. For example, if the mobile unit 32 is not configured to transmit signals, but only to receive them, the transceiver 54 may be replaced with, for example, a receiver. Processing requirements or operations for the CPU 50 and/or the memory 56 may be reduced in exemplary embodiments if the initial signal 30 is not generated or transmitted.

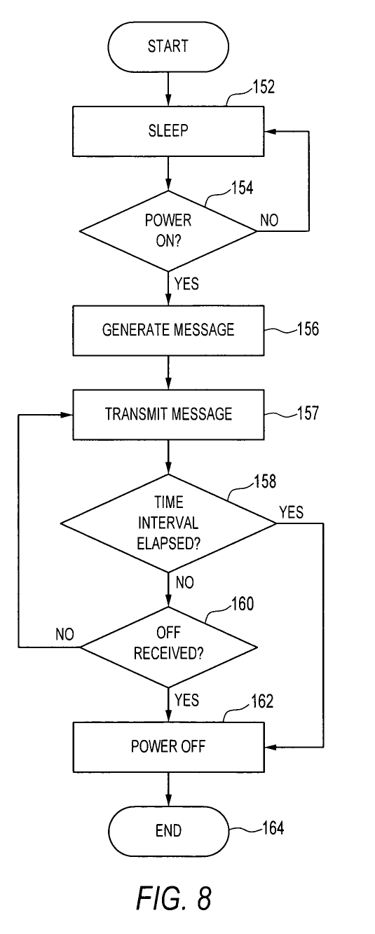

FIG. 8 shows an exemplary method for operation for the base unit 26 according to this second type of embodiment. The base unit 26 may be, for example, in a sleep or off mode (step 152) until interrupted or powered on (step 154) by an operator, for example. Alternatively, the base unit 26 may be always on. Once powered on, a message via the continuous or periodic signal 150 may be generated (step 156) and transmitted (step 157). It is contemplated that one or more of types of messages in the first type of embodiment could be generated and transmitted in methods according to the second type of embodiment as well, but it is preferred that communication originates from the base unit 26, and that the messages transmitted are preferably not selected in response to an initial signal from the mobile unit 30.

In certain cases, such as methods with customized responses, it is contemplated that the transmitted message may be suitably encoded for receipt only by selected mobile units 30; that is, mobile units belonging to (operated by) selected people. For example, an occupant of the fixed location 20 may only wish to tell particular people that he or she is not within the house. If the mobile unit 30 is able to decode an encoded signal transmitted from the base unit 26, it receives and processes the signal. The owner or the operator of the mobile unit 30 in this way will be able to determine simply by driving or walking by the fixed location 20 that the owner is not present. Multiple messages may be transmitted (for example, cyclically) and respectively encoded so that different recipients (mobile units 30) can receive and process different messages if they can be decoded.

Continuous or periodic information may be transmitted by the base unit 26 for processing by the mobile unit 30. Alternatively or additionally, the base unit 26 may be integrated with the meter 48 or a PC 46 as described above, and it may continuously or periodically transmit information relating to status of the fixed location 20.

The message transmitted by the base unit 26 may be transmitted for a particular time interval and/or until an off signal is received to cease transmitting the message and/or to power off the base unit. For example, referring to FIG. 8, after a message is transmitted (step 157), it is determined (step 158) whether a particular time interval has elapsed. If the time interval has not elapsed, it is then determined (step 160) whether, for example, an OFF signal has been received. Such an OFF signal may be received directly from an operator via the user interface 59. If an OFF signal is received, the base unit 26 powers off (step 162) and the process ends (step 164). If not, and a time interval has not elapsed, the message may be retransmitted. If the time interval has elapsed, the base unit 26 powers off (step 162). As an alternative to continuous transmission of a time interval, the base unit 26 may be configured to periodically transmit the signal 150 by, for example, introducing a pause between one or more transmissions. As in the first type of embodiment, a particular time interval or duration of transmission may vary as needed or desired.

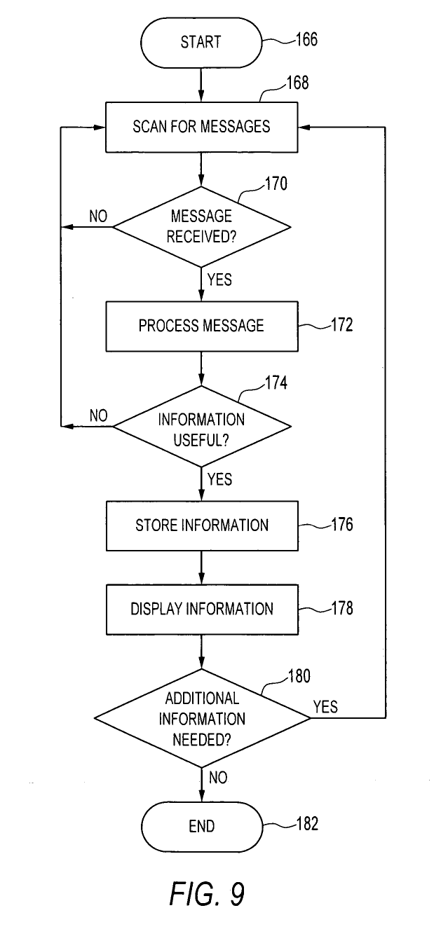

FIG. 9 shows an exemplary operation of the mobile unit 32 according to the second type of embodiment of the present invention. After startup (step 166), the mobile unit 32 scans for messages (step 168) from the base unit 26 transmitted via the continuous or periodic signal 150. The mobile unit 32 then determines whether a message has been received (step 170). In other words, it is determined whether a signal such as continuous or periodic signal 150 has been received by the antenna 52 and is able to be processed such that information may be ascertained. For example, the signal 150 may include an initial bit stream indicating that it is a message relating to a fixed location and thus is able to be processed by the mobile unit 32, or it may be encrypted. If no message is received (step 170) or if the message cannot be processed (for example, it cannot be decrypted) then the mobile unit 32 continues to scan for messages (step 168). It is contemplated that the mobile unit 32 may scan messages for a certain period of time, and that scanning may be continuous or periodic.

If a message is received (step 170) the message is processed (step 172) to determine information, that is, the contents of the message. A determination is made (step 174) whether the information is useful; that is, whether the information gleaned from the processed message is desired to be stored and/or displayed by the mobile unit 32. For example, if the mobile unit is configured to receive, process, and store information relating to meter reading, receipt of a message merely directed to address information may not be useful. The determination step (step 174) may be used to filter the incoming information according to policies determined by an operator. If the information is useful, the message preferably is stored (step 176) and displayed (step 178). For example, the message may be stored in the memory 56 of the mobile unit 32 and/or may be displayed on the display 58 in a similar manner to that shown in FIG. 6 or in a different manner.

After receiving and processing the message, the mobile unit 32 determines if additional information is needed (step 180). For example, the mobile unit 32 may determine that address information is useful but also needs meter information. In this case, the address information is stored (step 176) and displayed (step 178), but the mobile unit 32 continues to scan, receive, and process messages (steps 168, 170, 172) relating to meter reading or other status information. If additional information is not needed (step 180), the process ends (step 182).

It is contemplated that the mobile unit 32 may omit one or more steps of the exemplary process shown in FIG. 9, for example, a received message may not always be displayed and/or stored. Further, if a single message contains all pertinent information, the mobile unit 32 may not check for additional information (step 180). Further, it is to be understood that the particular length of time the mobile unit 32 scans for available messages and/or the time interval between such scanning may vary and the present invention is not intended to be limited to a particular scanning time or time interval.

In an exemplary application according to the second type of embodiment, a car is given an address to reach. The car is driving on the proper street, for example, but the number is not visible by the driver. The mobile unit 32 scans for and receives the transmitted signal 150, including address information. Next, the mobile unit 32 processes the signal, stores the correct address determined by processing, and displays the correct address on the display 58. As with the first type of embodiment, the second type of embodiment of the present invention may be integrated with existing GPS or other mapping programs.

As shown in FIG. 1, a single fixed location 20 may include the base unit 26 for transmitting the return signal 28 or the fixed signal 150 to the mobile unit 32 for processing. However, it is also contemplated that one or more base units 26 may cooperate or be replaced with a remote unit to allow a wider range of transmission and/or consolidate multiple transmissions, thus reducing overhead on individual base units 26 and possibly reducing the travel required for the mobile unit 32 to receive desired information. In this way, the remote unit acts as a relay and/or repeater for one or more base units 26. However, it is also contemplated that a single remote unit may replace the base units 26 from one or more fixed locations.

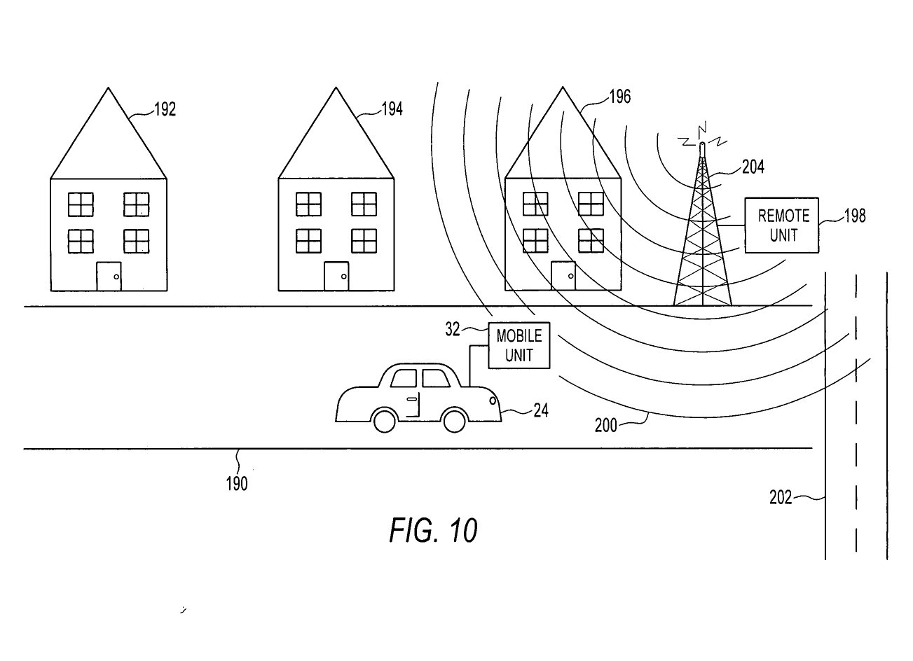

For example, FIG. 10 depicts a street 190 having a plurality of fixed locations 192, 194, 196, shown as houses. A remote unit 198 transmits a combined signal 200 to the mobile unit 32 of moving vehicle 24. The combined signal 200 may include, for example, a series of signals representing addresses or other information relating to the fixed locations 192, 194, 196. Such combined signals preferably are transmitted cyclically.

The fixed locations 192, 194, 196 may individually be linked to the remote unit 198 for providing address or status information to the remote unit for transmission. For example, one or more of the fixed locations 192, 194, 196 may include the base unit 26 (not shown in FIG. 10), which transmits a signal to the remote unit for further transmission or with signals relating to the other fixed locations. Alternatively, the fixed locations 192, 194, 196 may be linked to the remote unit 198 solely for providing status information, and the remote unit in turn may combine this status information with preprogrammed address information to generate the combined signal 200. As another example, the remote unit 198 may not be connected to the fixed locations 192, 194, 196, or only meters may be connected to the remote unit.

It is contemplated that various combinations or subcombinations of base units 26 and/or wired or wireless links between the fixed locations 192, 194, 196 and the remote unit may be used, and the present invention is not intended to be limited to a particular combination or combinations. Generally, the remote unit 198 enhances transmission capability for individual base units of individual fixed locations, replaces one or more base units, and/or combines information generated from a particular fixed location with information provided from other fixed locations to provide a combined signal for the mobile unit 32. However, in preferred embodiments the base unit or units 26, alone or via the remote unit 198, provide direct connection with the mobile unit 32, as opposed to communication via a wide-area network, a cellular network, the internet, etc.

In an illustrative example, the motor vehicle 24 may travel down a central street 202 and pass by the remote unit 198 communicating information for a particular street or street block, cul-de-sac, etc. The remote unit 198 in this exemplary embodiment may produce the combined signal 200 representing address and/or status information for all of the fixed locations 192, 194, 196 on its particular street. This may be performed with or without base units 26 from individual fixed locations, and the remote unit 198 may or may not be linked to one or more of the fixed locations 192, 194, 196 by wired or wireless connections, depending on particular embodiments. By traveling down the central street 202, the motor vehicle 24 need not divert its path from this main route to receive necessary address or status information.

For larger transmissions, it is contemplated that the remote unit 198 may be coupled to an external antenna 204, sufficiently powered to transmit combined signals 200 over a larger transmission area. However, it is to be understood that the generation of the combined signal 200 and/or individual signals from particular base units 26 is local in nature. In this way, the exemplary wireless system shown in FIG. 10 permits transmission of information over a fairly significant area, while affording the complexities of other large-scale communication systems. The remote unit 198 preferably may perform operations similar to the base unit 26 operations shown in FIGS. 4 and/or 8 in combination with, or in place of, one or more base units.

It is further contemplated that the remote unit 198 may be used to deliver information to the fixed locations 192, 194, 196 in place of, or in addition to, transmitting the signal 200. For example, if the mobile unit 32 is configured to transmit consumer information or alert information, the remote unit 198 may be configured to receive a general transmission from the mobile unit, and in turn repeat the signal for receipt by base units 26 or other receivers for the fixed locations 192, 194, 196. In a general sense, the remote unit 198 may operate as a repeater for transmitting address or status information from the fixed locations 192, 194, 196 to the mobile unit 32, and/or for transmitting information to the fixed locations.

Methods and configurations for the remote unit 198 may be similar to those described as to the base unit 26, with the optional addition of wired or wireless interfaces for performing the methods described above. Such interfaces may be with one or more of the fixed locations 192, 194, 196, or with base units thereof. Substitutions or combinations will be apparent to those of ordinary skill in the art.

One of ordinary skill in the art will appreciate that systems and methods for determining or transmitting address or status information for a fixed location 20, 192, 194, 196 have been shown and described, which have various features and attributes. Using the base unit 26 and the mobile unit 32, for example, wireless contact may be made between a moving vehicle 24 (or a pedestrian) and fixed locations 20, 192, 194, 196 to receive or transmit current, necessary, and/or helpful information to either party. However, the complexities and installation costs for larger-scale or more complex devices, such as those relying on satellite technology or internet technology, can be avoided in preferred embodiments. By providing direct links between the base unit 26 and the mobile unit 32 or links only via an intermediate unit such as the mobile unit 198, information can be quickly and accurately delivered between the fixed location 20, 192, 194, 196 and the moving vehicle 24 or pedestrian.

While various embodiments of the present invention have been shown and described, it should be understood that other modifications, substitutions, and alternatives are apparent to one of ordinary skill in the art. Such modifications, substitutions, and alternatives can be made without departing from the spirit and scope of the invention, which should be determined from the appended claims.

Various features of the present invention are set forth in the appended claims.

What is claimed is:

1. A method of identifying information for a fixed location, the method comprising the steps of:
wirelessly transmitting an initial signal from a mobile unit locally to a receiver at the fixed location;
receiving the initial signal by the receiver and automatically wirelessly transmitting a return signal locally to the mobile unit indicating the information for the fixed location;
receiving the return signal by the mobile unit;
processing the return signal to extract the identifying information.

2. The method of claim 1 wherein the information comprises an address of the fixed location.

3. The method of claim 1 wherein the mobile unit is transported by a moving vehicle.

4. The method of claim 1 wherein the receiver comprises a base unit disposed within the fixed location.

5. The method of claim 1 wherein the receiver comprises a remote unit that wireless transmits return signals for a plurality of fixed locations.

6. The method of claim 5 wherein the remote unit receives the initial signal from the mobile unit.

7. The method of claim 5 wherein the receiver further comprises a base unit at the fixed location that transmits the return signal to the remote unit, the return signal being relayed by the remote unit.

8. The method of claim 1 wherein the return signal includes a code representing the information.

9. The method of claim 8 wherein said processing comprises decoding the return signal.

10. The method of claim 8 wherein said processing comprises comparing the return signal to at least one of a relational database table and a lookup table.

11. The method of claim 1 wherein the initial signal is transmitted at least one of continuously and periodically.

12. The method of claim 1 wherein the receiver stores a plurality of pieces of information, and wherein the receiver selects and transmits at least one of the pieces of information based on the initial signal.

13. The method of claim 1 further comprising:
displaying the identifying information on at least one of the mobile unit and a device interfaced with the mobile unit.

14. A method of identifying information for a fixed location, the method comprising the steps of:
wirelessly transmitting a periodic or continuous signal within a local area that uniquely represents the information by a unit at the fixed location;
receiving the transmitted signal by a mobile unit entering the local area;
the mobile unit processing the received signal to extract the identifying information.

15. The method of claim 14 wherein said processing comprises comparing the received signal to at least one of a database and a look-up table.

16. The method of claim 14 wherein said transmitting the signal comprises:
transmitting the signal to a remote unit;
wirelessly transmitting the signal from the remote unit.

17. The method of claim 14 wherein said receiving the transmitted signal comprises:
the mobile unit scanning for incoming signals within the local area;
when the mobile unit is within the local area and after said transmitting the signal, receiving the signal.

18. A system for identifying information for a fixed location comprising:
a base unit in which is stored the information for the fixed location, said base unit including an antenna and a transmitter for wirelessly transmitting a signal indicating the information for the fixed location within a local area;
a mobile unit including an antenna and a receiver for receiving the wireless transmitted signal when said mobile unit is within the local area, said mobile unit further including a processor for processing the received signal and extracting the identifying information.

19. The system of claim 18 wherein said base unit is configured to transmit the signal repeatedly.

20. The system of claim 18 wherein said base unit is configured to transmit the signal on a periodic or continuous basis.

21. The system of claim 18 wherein said mobile unit further comprises a transmitter for transmitting an initial signal within the local area to the base unit, and wherein said base unit further comprises a receiver for receiving the initial signal;
said base unit further including a processor for processing the received initial signal and generating the signal in response to the initial signal.

22. The system of claim 21 wherein said base unit stores a plurality of pieces of information for the fixed location, and wherein the processor of said base unit includes a selector for selecting at least one of the pieces of information for transmitting based upon processing the received initial signal.

23. The system of claim 18 wherein the stored information for the fixed location comprises an address of the fixed location.

24. The system of claim 18 further comprising:
a remote unit including a receiver for receiving the wirelessly transmitted signal and re-transmitting the signal over a larger local area.

25. The system of claim 18 wherein said base unit stores information for a plurality of fixed locations, and wherein the wirelessly transmitted signal indicates information for the plurality of fixed locations.

26. The system of claim 18 wherein said mobile unit further comprises a display for displaying the extracted identifying information.

27. The system of claim 18 wherein the processor of said mobile unit is configured to analyze the extracted identifying information.

28. A system for identifying information for a fixed location comprising:
fixed means for storing the information for the fixed location;
fixed means for wirelessly transmitting a signal indicating the information for the fixed location within the local area;
mobile means for receiving the wirelessly transmitted signal;
means for processing the received signal to extract the identifying information.

29. The system of claim 29 further comprising:
means for repeatedly wirelessly transmitting the signal continuously or periodically.

30. The system of claim 28 further comprising:
means for wirelessly transmitting an initial signal within the local area:
means for receiving the initial signal;
means for processing the received initial signal and selectively wirelessly transmitting the signal in response.

31. The system of claim 30 wherein said means for storing comprises means for storing a plurality of pieces of information for the fixed location, and wherein said means for processing comprises means for selecting at least one of the pieces of information for transmission based upon the received initial signal.

32. The system of claim 28 wherein said fixed means for storing stores information for a plurality of fixed locations, and wherein said fixed means for wirelessly transmitting transmits a signal indicating the information for the plurality of fixed locations within the local area.

33. The system of claim 28 further comprising:
means for receiving the transmitted signal within the local area;
means for re-transmitting the received transmitted signal over a larger local area.

34. The system of claim 28 wherein the information for the fixed location comprises address information.

35. The system of claim 28 further comprising:
means for displaying the extracted identifying information.

36. A method of transmitting a consumer or alert message to a fixed location comprising:
generating a signal representing the consumer or alert message;
wirelessly transmitting the generated signal within a local area of the fixed location;
receiving the transmitted signal by a receiver at the fixed location;
automatically processing the received signal to extract the consumer or alert message.

37. A system for transmitting a consumer or alert message to a fixed location comprising:
a mobile unit in which is stored the consumer or alert message, said mobile unit including an antenna and a transmitter for wirelessly transmitting a signal indicating the consumer or alert message within a local area of the fixed location;
a base unit including an antenna and a receiver for receiving the wirelessly transmitted signal when said mobile unit is within the local area, said base unit further including a processor for processing the received signal and extracting the consumer or alert message.
